(19) United States
(12) Patent Application Publication
(10) Pub. No.: US 2006/0105821 A1
(43) Pub. Date: May 18, 2006

(54) Wrap-around carrying case for cell phone or other personal electronic device

(75) Inventors: Harold S. Goradesky, Fort Lauderdale, FL (US); Erik Turocy, Columbus, OH (US)

Correspondence Address: Robert C. Kain, Jr.;Fleit, Kain, Gibbons, Gutman & Bongini, P.L., Suite 100, 750 Southeast Third Avenue, Ft. Lauderdale, FL, 33316-1153, US

(73) Assignee: A.G. Findings & Manufacturing Co., Inc.

(21) Appl. No.: 11/254,102

(22) Filed: Oct. 19, 2005

Related U.S. Application Data
(63) Continuation-in-part of application No. 11/118,651, filed on Apr. 30, 2005.
(60) Provisional application No. 60/608,023, filed on Sep. 8, 2004.
(60) Provisional application No. 60/672,706, filed on Apr. 19, 2005.

(51) Int. Cl. H04B 1/08; H04M 1/00

(52) U.S. Cl. 455/575.1; 455/347

(57) ABSTRACT

The carrying case includes front, rear and other sides having at least one swath of elastic material to laterally compress the phone or personal electronic device in the carrying case. The addition of releasable fasteners and/or a strap permits adjustment of the lateral compression. The fasteners may replace the elastic panel. The further addition of a base or bottom cap limits shock and protects the bottom of the carried device. A laterally extending tab can be utilized to enhance further portability of the carrier. A swing cap may be utilized to cover the top end of the carried device.

This is a continuation in part of patent application Ser. No. 11/118,651, filed Apr. 30, 2005, now pending, which was a regular application based upon and claiming the benefit of priority provisional patent application 60/608,023 filed Sep. 8, 2004, and further the present application is a regular patent application which claims the benefit of priority of provisional patent application No. 60/672,706, filed Apr. 19, 2005, now pending.

The present invention relates to a wrap-around carrying case for cellular telephones or other personal electronic devices such as personal data assistants (PDA), digital cameras (movie cameras and still cameras), small portable digital video players, digital memory store music players (for example, IPODS (Apple Computer Co. trademark)), MP3 players, small portable game players, digital video players and other small, portable, electronic devices commonly carried by a person.

### BACKGROUND OF THE INVENTION

Many persons carry cellular telephones and/or other personal electronic devices such as personal data assistants (PDAs). Cell phones and PDAs audibly announce a call to the user (the person carrying the personal electronic device). If the cell phone or device is located in a briefcase, purse, handbag or backpack, the user does not hear the audible announcement and does not respond to the phone or PDA. Therefore, many persons carry cell phones and other small electronic devices on their belts, purse straps or on a tether which loops around the person's neck or over their shoulder or through straps on the handbag, purse or backpack. Additionally, some people carry digital memory store music players such as MP3 players and IPODs which play music through earphones inserted into the ear of the user. Portable game players, such as the PS2 (Sony trademark) game player, are also carried by users. These personal electronic devices are typically carried in a pocket or attached to a belt or a purse strap by a tether or strap discussed above. Digital cameras (movie and still) are sometimes carried in quickly accessible places on a person's body such that the person can quickly remove the camera and capture a unique event in a camera digital memory store. Digital video players are also portable devices.

In these situations, when the cell phone or other personal electronic device is carried on the outside of the body of the user (or on a purse or strap), the cell phone or personal electronic device is subject to damage by being dropped, by ejection of the cell phone or device from the holster or carrier or damaged if the user bumps a wall, door jam or other object when the cell phone or device is hung on or attached to user's belt, tether or purse strap. Therefore, it is beneficial to provide a carrying case which reduces impact and shock to the cell phone or personal electronic device and permits quick insertion and release upon a call to the user or upon demand of the user (such as when the user wants to quickly take a picture with a digital camera retained by a carrier).

Further, repeated insertion and removal of the phone or device causes wear on the exposed edges of the carrier.

### OBJECTS OF THE INVENTION

It is an object of the present invention to provide a wrap-around carrying case for cellular telephones or other personal electronic devices.

It is another object of the present invention to provide a wrap-around case which contains elastic panels which laterally compress and entrap the cell phone or personal electronic device therein.

It is a further object of the present invention to provide a carrying case including user adjustable straps or belts to adjust the lateral compression of the item carried by the carrier.

It is an additional object of the present invention to provide laterally extending straps, tabs or swivels such that the carrying case can easily be carried or attached to other items by the person.

It is an additional object of the present invention to provide a carrying case that has side impact cushion panels which reduce or avoid damage due to laterally directed shock forces.

It is a further object of the present invention to provide a carrying case with a bottom boot cap which limits damage to the cell phone or device if the cell phone or device and carrying case is dropped.

### SUMMARY OF THE INVENTION

In one embodiment the carrying case includes front, rear and other sides having at least one swath of elastic material to laterally compress the phone or personal electronic device in the carrying case. The addition of releasable fasteners and/or strap permit adjustment of the lateral compression. Fasteners or straps may replace the elastic panel. The further addition of a base or bottom cap limits shock and protects the bottom of the carried device. A laterally extending tab can be utilized to enhance further portability of the carrier. Swivel clips may also enhance portability. A swing cap may be utilized to cover the top end of the carried device.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates a carrying case having a wrap-around body portion, a elastic cloth band or swath portion and a laterally extending, planar tab.

FIG. 2 diagrammatically illustrates a bottom perspective view of the carrying case and shows that wrap-around panel and side panels with a cushion edge.

FIG. 3 diagrammatically illustrates a perspective end view wherein the cell phone or other personal electronic device has been withdrawn from capture cavity or space established by carrying case.

FIG. 4 diagrammatically illustrates a carrier having side cushion panels that extend generally along side panel and also along part of side panel.

FIG. 5 diagrammatically illustrates an end view of carrier and shows side with cushion panel.

FIG. 6 diagrammatically illustrates a carrier wherein side includes a side panel cushion which extends from an upper cushion edge to a lower cushion edge.

FIG. 7a diagrammatically illustrates cell phone or a portable electronic device (herein “PED”) carrier with a wrap-around flap.

FIG. 7b diagrammatically illustrates a portion of the cross-section of carrier of FIG. 7a having a bottom side and a rear side attached to an elastic panel.

FIG. 8a diagrammatically illustrates a carrier having an open end and an open bottom with a wrap around strap.

FIG. 8b diagrammatically illustrates is a cutout segment “C” of the carrier of FIG. 8a.

FIG. 8c diagrammatically illustrates that strap includes a releasable fastener which enables the user to tighten or loosen the carrier about the cell phone or PED.

FIG. 8d diagrammatically illustrates the attachment of the strap to a side.

FIGS. 9a-9f diagrammatically illustrate various releasable fastener systems for carriers.

FIG. 10a diagrammatically illustrates a carrier having a side panel with a plurality of raised cushion bands.

FIG. 10b diagrammatically illustrates a carrier with a side panel having several raised cushion bands.

FIG. 10c diagrammatically illustrates a side panel having an initial raised cushion band which leads to another raised cushion band and to further a further raised cushion band.

FIG. 11 diagrammatically illustrates a carrier with a side having a cushion band, an elastic panel and a strap over the panel.

FIG. 12 diagrammatically illustrates that the side panels are attached together via an elastic panel.

FIG. 13 diagrammatically illustrates a carrier with a side panel and an elastic panel and a strap.

FIG. 14 diagrammatically illustrates a carrier with a side panel connected to elastic panel portion and a fastener strap extending over the elastic segment of the carrier.

FIG. 15 diagrammatically illustrates a carrier with an elastic panel attached at one side to another side panel and attached at its other side to a strap element.

FIG. 16 diagrammatically illustrates a carrier with a side panel attached to further elastic panels.

FIG. 17 diagrammatically illustrates a carrier with a side panel and a first strap and a second strap.

FIG. 18 diagrammatically illustrates a carrier with a side panel having bands of cushion material also connected to a partial elastic panel.

FIG. 19 diagrammatically illustrates a carrier with a side panel segmented into side panel regions with a partial elastic panel therebetween.

FIG. 20 diagrammatically illustrates a carrier with cell phone or PED disposed about axis A′-A″.

FIGS. 21a, 21b and 21c diagrammatically illustrate a carrier which includes various elements discussed earlier including a protruding tab which protrudes from elastic panel segments.

FIG. 22a diagrammatically illustrates that cell phone or PED is entrapped by wrap-around carrier.

FIG. 22b diagrammatically illustrates a carrier with a bottom cap having a lower elevation resilient land segment, a higher land resilient segment and a supplemental lower land.

FIG. 23a diagrammatically illustrates a carrier with a side panel and various cushion panel elevations.

FIG. 23b diagrammatically illustrates a carrier with a flap element which is permanently attached to a side panel or is releasably affixed to the side panel.

FIG. 24a diagrammatically illustrates a carrier with a tab extending above a side panel.

FIG. 24b diagrammatically illustrates a carrier with a side panel and cushion elements.

FIG. 25a diagrammatically illustrates a carrier which includes a flap that is removably attached to a side panel by rings.

FIG. 25b diagrammatically illustrates removal of rings from U shaped hooks on the carrier of FIG. 25a.

FIG. 26a diagrammatically illustrates a carrier with a side panel having a substantial elastic panel.

FIG. 26b diagrammatically illustrates a carrier with a strap disposed over an elastic panel.

FIG. 27a diagrammatically illustrates a carrier with a strap with an end portion removably attached to a side panel.

FIG. 27b diagrammatically illustrates a carrier of FIG. 27a with a flap attached to side panel at end segment.

FIG. 28a diagrammatically illustrates a carrier with cell phone or PED shown in dashed lines which phone is retained in a capture space via strap extending above a side panel.

FIG. 28b diagrammatically illustrates a partial, side view of a carrier shown in FIG. 28a and a tab and aperture extending above a strap.

FIG. 29 diagrammatically illustrates a carrier with a side panel and a cushion element and a protruding tab.

FIGS. 30a, 30b diagrammatically illustrate a carrier with a strap removably affixed to a side panel via a ring and a U shaped hook.

FIGS. 31a and 31b diagrammatically illustrates a carrier with a strap and a ring loop linking the strap to a side.

FIG. 32a diagrammatically illustrates a carrier with a side panel and a strap system which wraps around cell phone or PED.

FIG. 32b diagrammatically illustrates a carrier with a strap end which enables the user to enhance or relax the lateral compression of the wrap around system for the cell phone placed in space.

FIGS. 33a, 33b diagrammatically illustrate a carrier with a side which is laced with a lacing system at the interface between its sides.

FIGS. 34a, 34b diagrammatically illustrate a carrier with a flap which is removably attached at end region to a side panel.

FIGS. 35a, 35b diagrammatically illustrate a carrier with various sides and a swing cap.

FIGS. 36a, 36b and 36c diagrammatically illustrate a carrier with a side panel and a releasable flap.

### DETAILED DESCRIPTION

The present invention relates to a wrap-around carrying case for cellular telephones or other personal electronic devices such as personal data assistants (PDA), digital cameras, digital memory store music players (for example, IPODS (Apple Computer Co. trademark)), small portable digital video players, digital MP3 players, small portable game players and other small, portable, electronic devices commonly carried by a person. Similar numerals designate similar items throughout the drawings. Although reference is made herein to the use of a wrap-around carrier for a cell phone, the carrier can be easily adapted to carry other small, portable, electronic devices. Reference to a “cell phone” in the drawings and in this detailed description also incorporates and refers to such other small, portable, electronic devices.

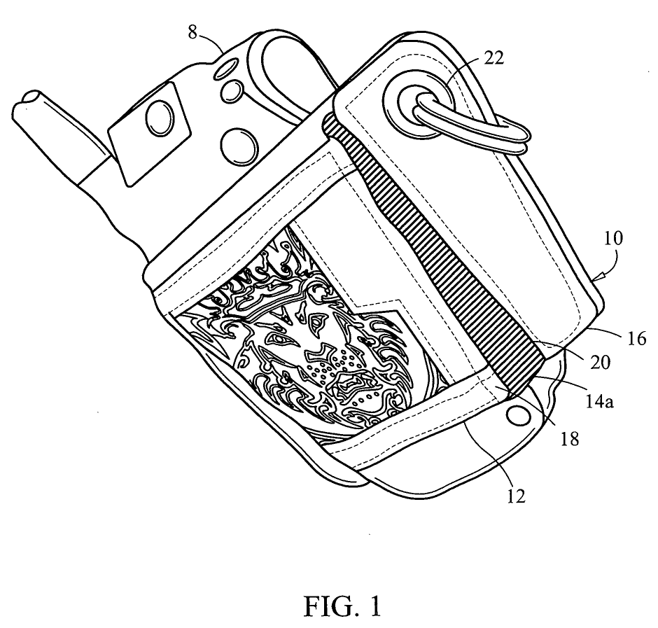

FIG. 1 shows carrying case 10 having a wrap-around body portion 12, a elastic cloth band or swath portion 14a and a laterally extending, planar tab 16. Wrap-around body portions are sometimes referred to herein as first, second and third sides or as front, rear and first and second opposing sides. The elastic panels or bands of material may comprise one of these sides but typically, not the front nor the rear sides. In one embodiment, elastic swath portion 14a is sewn or attached to edge 18 of wrap-around panel 12 and edge 20 of extending planar tab 16. As discussed later, the tab 16 is an accessory device which may be omitted. Although a cell phone 8 is shown mounted within carrying case 10 in FIG. 1, the cell phone may be any other personal electronic device such as a PDA, digital camera, digital video player, digital memory store, music player, small portable game player or other small portable electronic device commonly carried by a person. Laterally extending planar tab 16 includes in the illustrated embodiment of FIG. 1 an aperture 21 defined by a grommet 22. Grommet 22, or the functional equivalent hole 21 in tab 16 defined by the grommet, is adapted to retain a tether, chain, string or cord such that the user can carry the unit 10 and the cell phone 8 or other small portable electronic device.

Elastic expansive panel 14a expands or contracts to match the size of the cell phone or other small portable electronic device inserted into the carrier 10. Elastic panel 14b provides the same functionality. Therefore, carrier 10 can retain a reasonably wide variety of cell phones and/or other small portable electronic devices.

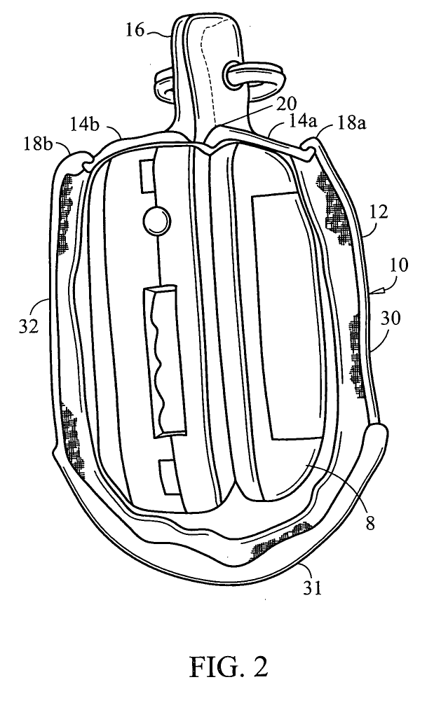

FIG. 2 shows a bottom perspective view of carrying case 10 and shows that wrap-around panel 12 has side panels 30, 32 and a cushion edge side panel 31. Side panels 30, 32 may be referred to as front and rear sides. The elastic cloth panels 14a, 14b have one edge sewn to laterally extending or outboard protruding planar tab 16 along edge 20 of elastic panel 14a and the other edge sewn to side panel 30 at edge 18a. Elastic panel 14a, 14b is at the interface between adjacent sides 30, 32. In other words, in the absence of elastic panel 14a, 14b, sides 30, 32 would be attached or affixed together in the carrier 10. The sides 30, 32 are adjacent because they are near each other. The elastic panel 14a, 14b is interposed between these adjacent sides 30, 32. Elastic panel 14b is sewn at edge 18a to side panel 32. The hole 21 surrounded by the grommet in planar tab 16 may retain a swivel clip or a tether.

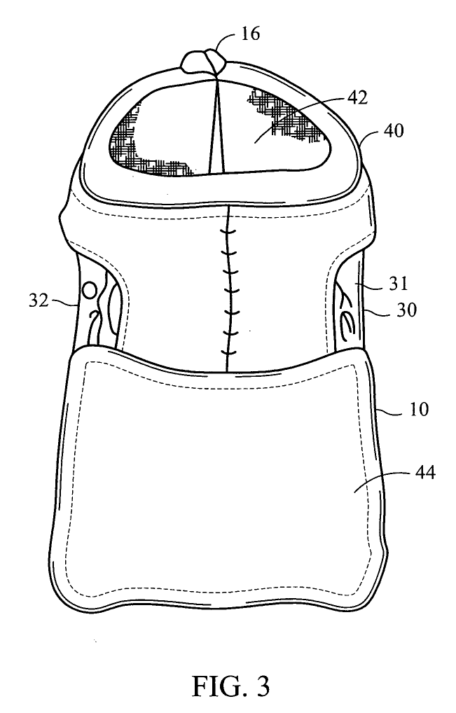

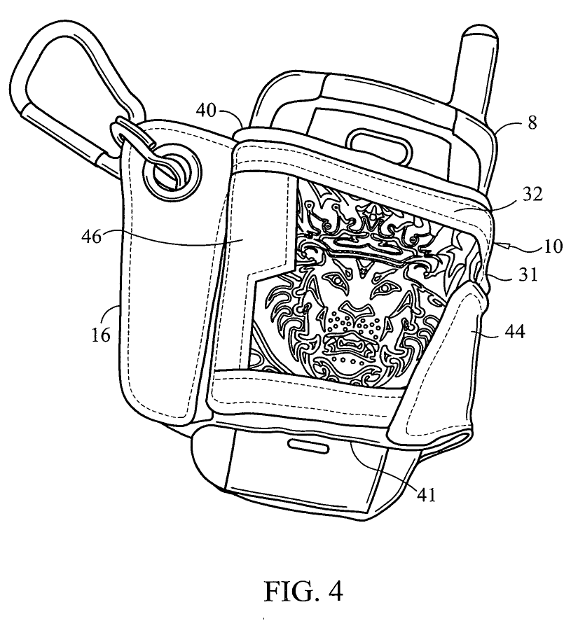

FIG. 3 shows a perspective end view wherein the cell phone or other personal electronic device has been withdrawn from capture cavity or space 42 established by carrying case 10. As shown in FIG. 3, the elastic panels 14a, 14b have collapsed such that the space 42 is dramatically smaller than the cell phone or other personal electronic device. This illustration shows the proximity of sides 30, 32. The lateral, cross-sectional aspect of space 42 (normal to the direction of insertion of cell phone 8) is cone shaped or an ovoid with a pointed end defined by the elastic panels 14a, 14b. Further, space 42 has an open end (defined by cushion edge 40, FIG. 4) and, in general, is open such that the user can easily insert or withdraw the cell phone or personal electronic device into and out of carrier 10. The cushion edge reduces or eliminates wear on the edge of the carrier due to repeated insertions. Insertion of cell phone or personal electronic device 8 causes the expansion of elastic panels 14a, 14b such that the cell phone or personal electronic device is laterally compressed in space 42 (see FIG. 1). Further, side panels 30, 32 and elastic panels 14a, 14b encircle the cell phone or personal electronic device.

FIG. 3 also shows a cushion side panel 31 which limits, reduces or eliminates damage due to impact from a laterally directed force to side area of the cell phone or other personal electronic device. As shown, cushion side panel 31 is disposed on sides 30, 32 and is raised with respect to sides 30, 32. The cushion side panel 31 is a band of cushioning material.

FIG. 3 also shows that the upper edge 40 of carrier 10 has a rounded, soft cushion. This rounded, soft cushion edge 40 reduces wear at the upper edge and the lower edge 41 (FIG. 4) and permits easy insertion and withdrawal of the cell phone or other personal electronic device into and out of carrier 10.

FIG. 4 diagrammatically illustrates carrier 10 having side cushion panels 44 that extend generally along side panel 31 and also along part of side panel 30. Upper cushion edge 40 and lower cushion edge 41 are shown in FIG. 4. The laterally extending tab 16 always laterally extends due to the utilization of a two elastic panel system 14a, 14b shown in FIG. 2. Sewing the laterally extending tab 16 to the adjacent edges of elastic panels 14a, 14b ensures that laterally extending tab 16 always protrudes in a generally planar fashion along the center line of the pointed ovoid or along the generally lateral center plane of carrier 10. Further, the lateral planar tab 16 extends the height or the y axis of carrier 10.

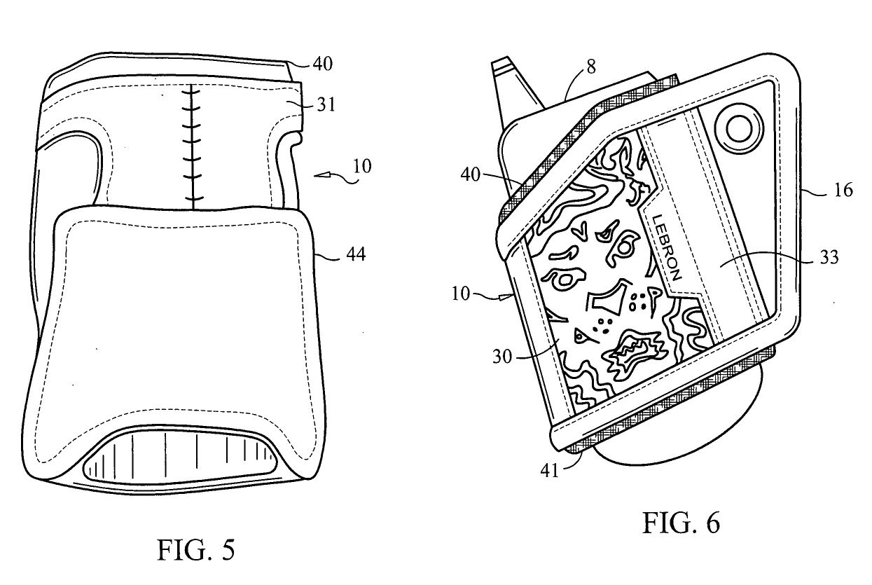

FIG. 5 shows an end view of carrier 10 and shows side 31 with cushion panel 44. Cushion panel 44 is a raised land over cushion panel 31. Cushion panels reduce impact damage to the item carried by carrier 10.

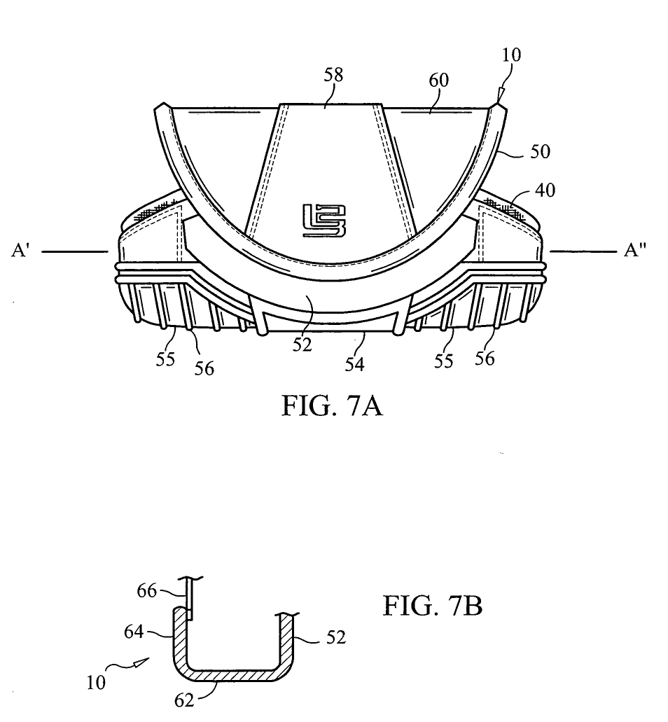

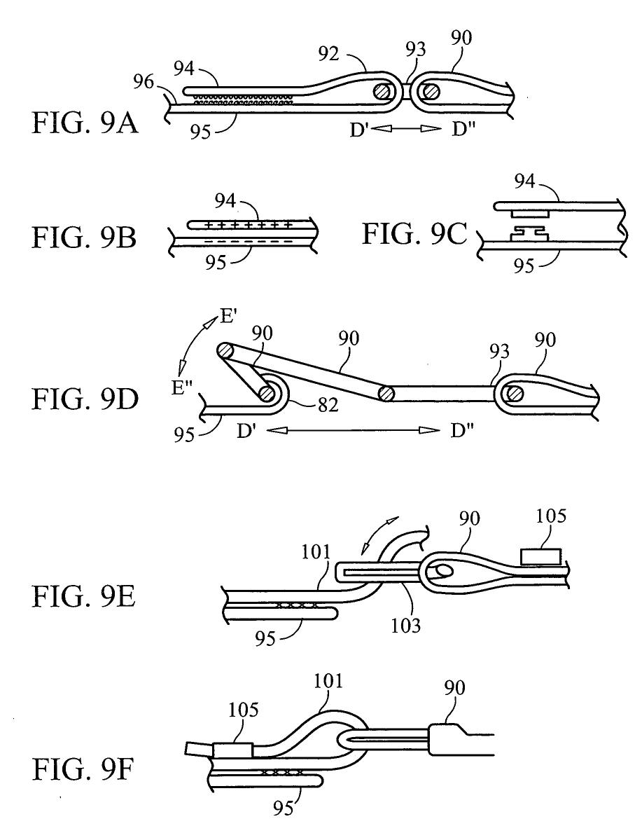

FIG. 7a diagrammatically illustrates cell phone or a portable electronic device (herein “PED”) carrier 10 with a wrap-around flap 50. The cell phone or PED as a longitudinal axis complementary to axis A′-A″ in carrier 10. Flap 50 wraps around one side of the cell phone or PED. Cushion edge pad 40 cushions the insertion of the cell phone or PED. Side 52 includes a band of cushion material 54. This band of cushion material is preferably a land of resilient plastic. Further raised lands 56 extend above the lower surface 55 of cushion 54. This provides additional cushioning effect and provides a tactile grip region about that portion of carrying case 10. Cushion band 58 on side 60 also provides cushion for laterally directed forces on that portion of carrier 10. As discussed later, flap 50 can be affixed to side 52 or may be releaseably fastened to side 52 by various mechanisms including, but not limited to, a cloth hook and loop system (VELCRO), a magnetic clasp or a snap. See FIGS. 9a-9c. Additionally, flap 50 may be permanently affixed to side 52.

FIG. 7b shows a portion of the cross-section of carrier 10 of FIG. 7a having a bottom side 62 and a rear side 64 attached to elastic panel 66. The other side of elastic panel 66 is attached to flap 50. In this manner, the interior space or cavity defined about axis A′-A″ can expand or contract dependant upon the required compression on the cell phone or PED located in that interior space.

FIG. 6 shows carrier 10 wherein side 30 includes a side panel cushion 33 which extends from upper cushion edge 40 to lower cushion edge 41.

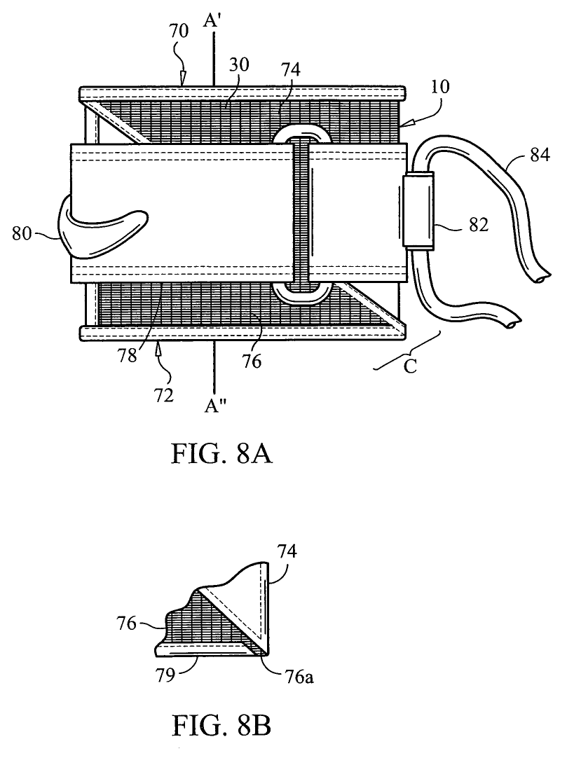

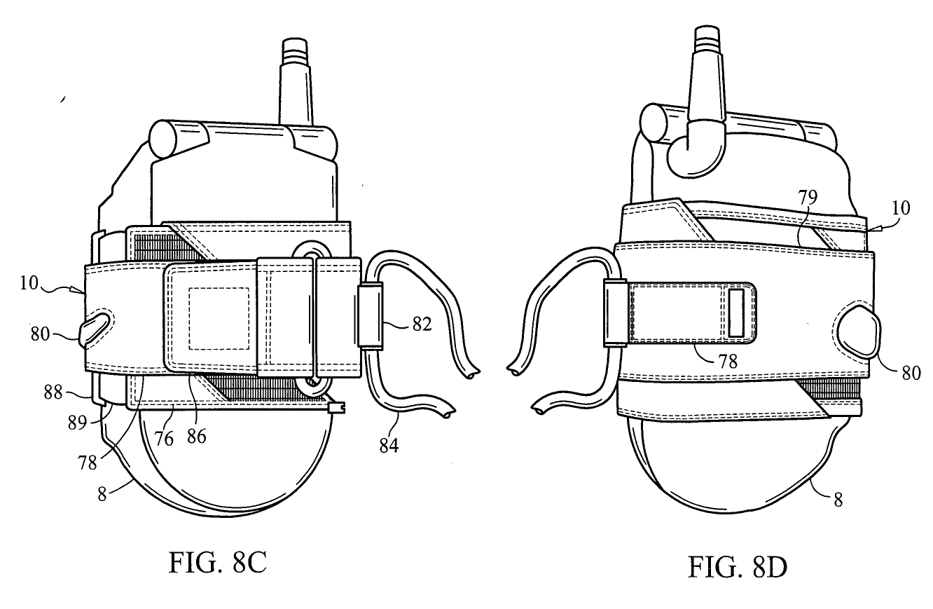

FIG. 8a shows carrier 10 having an open end 70 and an open bottom 72. Side 30 is defined by material or nylon panel 74 and an elastic panel 76. A fastener or strap 78 extends over elastic panel 76. Strap panel 78 includes a side cushion element 80 which absorbs impact and force laterally directed to a cell phone or PED stored in carrier 10 about carrier axis A′-A″. The phone or PED can be inserted in either opening.

FIG. 8b is a cutout about arcuate segment C of FIG. 8a. This detail shows nylon panel 74 and elastic panel 76. Elastic panel 76 has an edge bead 79 which is separated from nylon panel 74 by elastic segment 76a. This permits the elastic panel to expand and contract to adjust and encircle and entrap a cell phone or PED disposed about axis A′-A″. Strap 78 in FIG. 8a includes loop or rim or cylinder 82 through which tether 84 extends. The user by utilizing tether 84 in loop or ring 82, is permitted to hang the phone or PED on his or her body, neck, purse or other item.

FIG. 8c diagrammatically illustrates that strap 78 includes a releaseable fastener 86 which enables the user to tighten or loosen the carrier 10 about the cell phone or PED. Also, FIG. 8c shows that side panel 86 and rear panel 88 are connected together by elastic panel 89.

FIG. 8d illustrates the attachment of strap 78 to side 79.

FIGS. 9a-9f diagrammatically illustrate various releaseable fastener systems. The fastener system in FIG. 9a includes first loop 90 and second loop 92 which are joined together by ring 93. The ring may be ovoid. The user can adjust the lateral span distance (see span D′-D″) by releasing and reattaching flap 94 with respect to base panel 95. Cloth hook and loop fastener system (VELCRO) 96 is shown at the interface or opposing side surfaces of flap 94 and base panel 95. The releaseable fastener of FIG. 9a may be used for carrier 10 in FIG. 8a. Many carriers herein may incorporate the cloth hook and loop fastener systems.

FIG. 9b shows that flap 94 and base panel 95 include a magnetic clasp. In the illustrated embodiment, base 95 is charged in one manner and flap 94 carries a different or magnetic charge.

FIG. 9c shows that base panel 95 includes a male snap element and flap 94 includes a female snap element. Of course, the male and female snap elements may be on opposite side than illustrated in FIG. 9c. Buttons or T-bar clasps may also be used on panel 95 and flap 94.

FIG. 9d shows a linkage mechanism wherein ring bar 93 is adjusted in linear span direction D′-D″ based upon the linkage system with link arms 97, 98 and hook element 99. Hook element 99 is affixed or formed on panel side 95. When link system 98, 97 is moved as shown in direction E″, the space between hook 99 and first loop 90 decreases thereby tightening the releaseable fastener and firmly grasping the cell phone or PED in the interior of the carrier. When the link system 98, 97 is moved in the direction of E′, the span distance D between hook 99 and loop 90 increases thereby releasing the cell phone or PED captured by the carrier.

FIGS. 9e and 9f show a belt clasp or a tongue clasp wherein tongue element 101 is attached to side panel 95 and passes through belt clasp 103. The user adjust the tightness of this releaseable fastener by tightening or loosening the belt tongue 101 with respect to fixed loop 90. A bar or spindle, not shown, passes through holes in tongue 101. The bar is rotatably mounted in clasp 103. The end of the belt tongue 101 may be placed in loop holder 105. In FIG. 9f, belt tongue 101 is looped back upon itself and threaded through tongue retainer loop 105.

It should be noted other types of lock and release systems for the fasteners may be utilized. For example, a snap is shown in FIG. 9c, but a button or toggle system could be utilized. A toggle system would simply be a T bar placed on the end of belt tongue 101 in FIG. 9e and the toggle bar could pass through an appropriately sized hole in belt clasp 103.

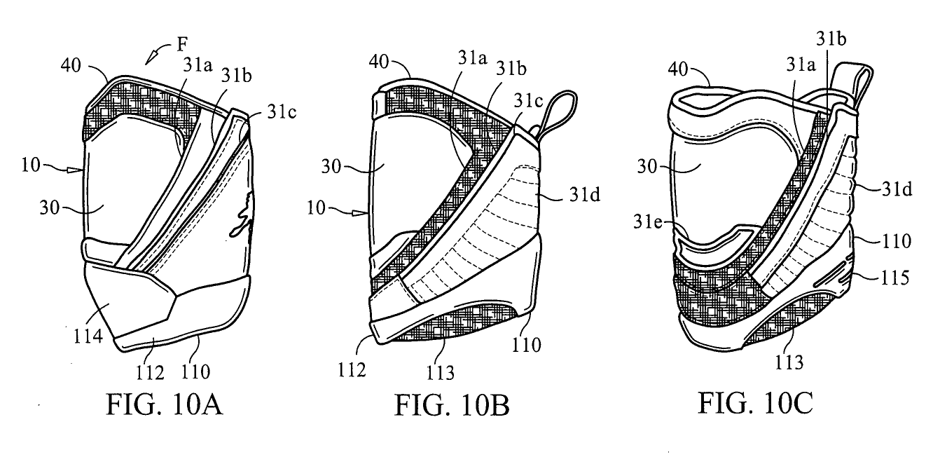

FIG. 10a shows carrier 10 having a side panel 30 with a plurality of raised cushion bands 31a, 31b and 31c. In addition, the bottom of the carrying case 10 includes a boot cap 110. Boot cap 110 is a bottom of resilient plastic and, as illustrated in FIG. 10a, includes a raised surface 112 which is higher than surface 114. The boot cap encases and protects the base of a cell phone or PED device which is inserted in the direction shown by arrow F. Boot cap 110 is made of resilient plastic. If the phone or device is dropped, the carrier cap 110 cushions for the drop-fall force impact.

FIG. 10b shows carrier 10 with a side panel 30 having raised cushion bands 31a and a second raised cushion band 31b. Cushion region 31b has a reduced or lower elevation as compared with cushion land 31c. Boot 110 includes a raised land 112 of resilient plastic and a lower elevation land 113.

FIG. 10c shows side panel 30 having an initial raised cushion band 31e which leads to raised cushion band 31a and to further raised cushion band 31b. Bottom cap 110 has small raised lands 115 which provide a tactile grip region about the bottom cap 110. The tactile grip enables the user to quickly grasp the carrier and remove the entrapped device.

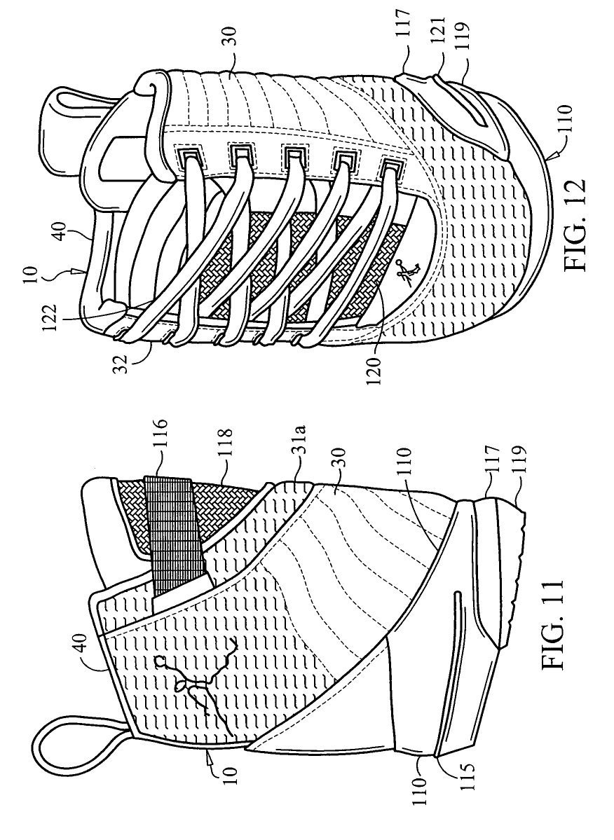

FIG. 11 diagrammatically shows carrier 10 with side 30 having cushion band 31a. Bottom cap 110 includes a raised land 115 and supplement raised lands 117, 119 which provide cushioning from shock since those raised lands 117, 119 are made of resilient plastic material. The bottom of the cell phone or PED is protected by a force directed at the bottom or the lower edge regions of carrier 10 due to the unique construction of bottom cap 110. It is well known that cell phones and PEDs are mainly damaged after they are dropped by their users.

Carrier 10 in FIG. 11 also includes a strap or overlay panel of elastic material 116. Alternatively, panel 118 may be elastic material and element 116 may be a strap adjustable by the user. Both 116 and 118 may be elastic material.

FIG. 12 shows that side panels 30, 32 are attached together via elastic panel 120. Further, a lacing system or lacing fastener 122 (a releasable fastener system) extends over elastic panel 120 and spans side panels 30, 32. This enables the user to lace or tighten side panels 30, 32 by adjusting the lacing system 122. Bottom cap 110 includes lands of resilient material 117, 119 and a further raised land 121 providing either additional cushioning in the event of a laterally directed shockwave or a tactile grip region.

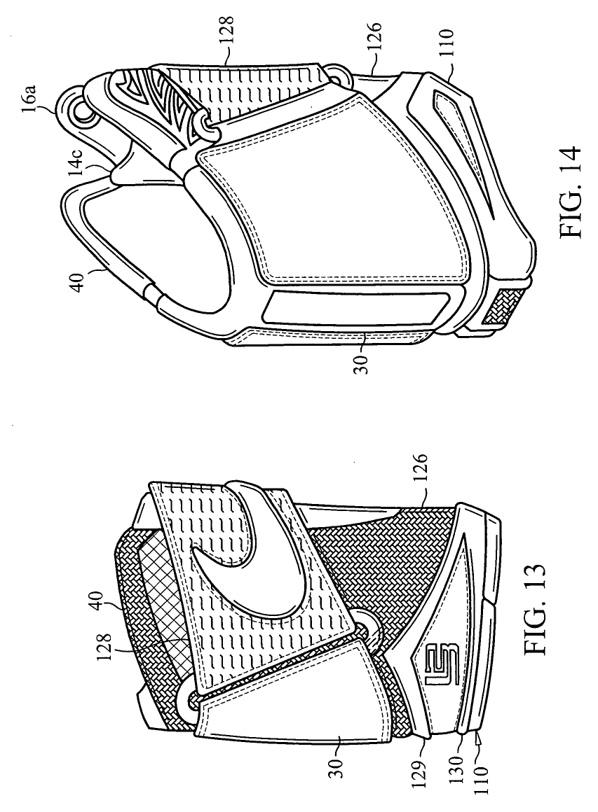

FIG. 13 shows a carrier with side panel 30 and an elastic panel 126. A releaseable strap system 128 extends over elastic panel 126. Bottom cap 110 includes raised lands 129, 130.

FIG. 14 shows a carrier with side panel 30 connected to elastic panel portion 126 and fastener strap 128 extending over the elastic segment of the carrier. A tab 16a is attached to side wall 14c.

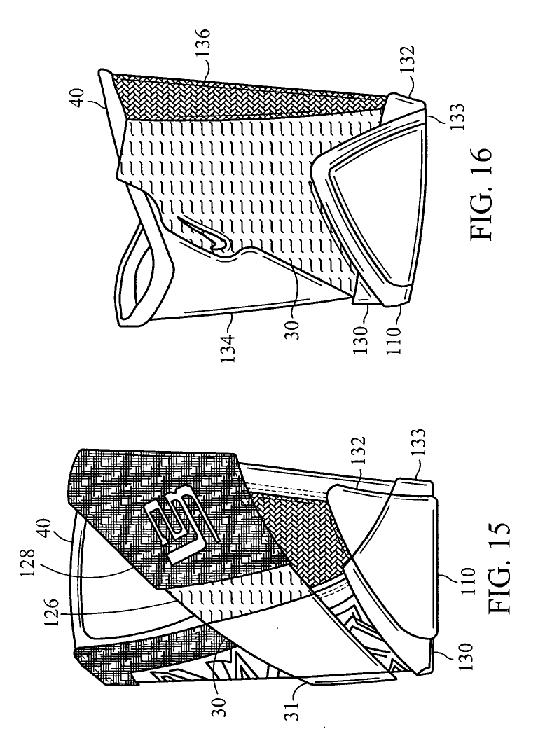

FIG. 15 shows a carrier with elastic panel 126 attached at one side to side panel 30 and attached at its other side to strap element 128. Side panel 30 may include cushion band 31. Bottom cap 110 includes various elevational levels of resilient material including levels 130, 132 and 133.

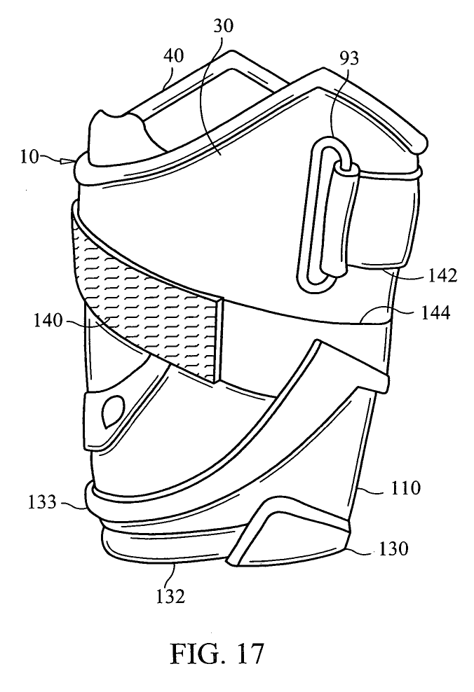

FIG. 16 shows a carrier with side panel 30 attached to elastic panels 134, 136. Bottom cap 110 includes resilient lands and lower and higher elevations of lands 130, 133 and 132.

FIG. 17 shows a carrier with side panel 30 and a first strap 140 and a second strap 142. Second strap 142 is adjustable and includes, on the non-illustrated side, a releaseable fastener system as discussed earlier in conjunction with FIGS. 9a-9f. Alternatively, band 142 may entirely wrap-around carrier 10 such that band strap 140 is part of band strap 142. Band strap 140 may be connected to base band 144 by a cloth hook and loop system or a magnetic clasp or a button or snap as shown in FIG. 9a-9c. The various elevational lands of bottom cap 110 are shown as higher and lower elevations 130, 132 and 133.

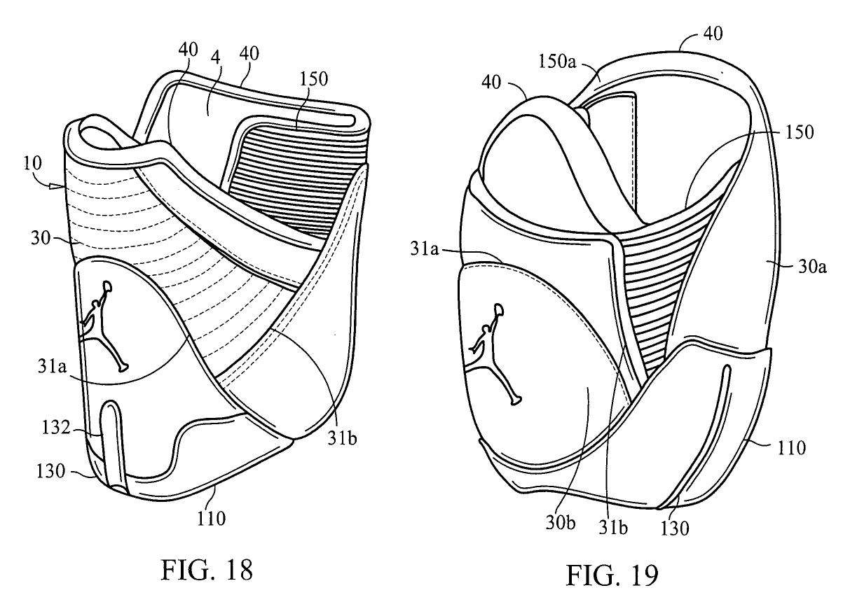

FIG. 18 shows a carrier with side panel 30 having bands of cushion material 31a, 31b, also connected to a partial elastic panel 150. Cushion edge 40 extends about the open top space 4 of carrier 10.

FIG. 19 shows a carrier with side panel 30 segmented into side panel regions 30a and 30b with the partial elastic panel 150 therebetween. The rear side has elastic panel 150a. Raised land 130 rises above the elevation of bottom cap 110. Further, several layers of cushion material have been applied to side panel element 30b. See cushion bands 31a, 31b.

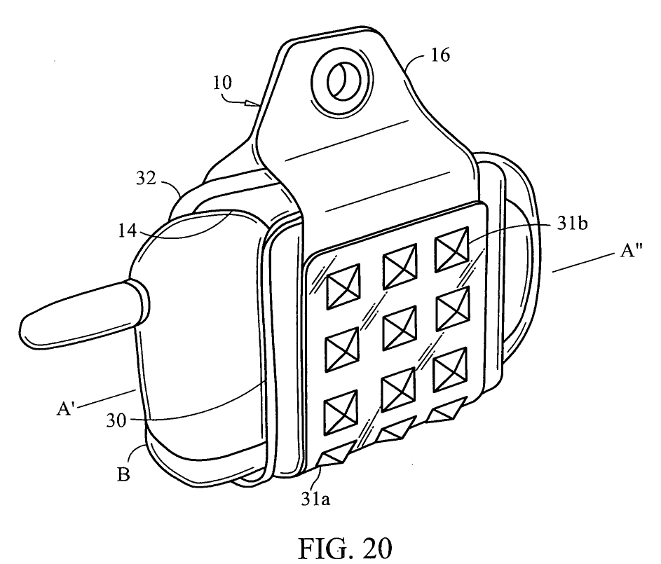

FIG. 20 shows carrier 10 with cell phone or PED 8 disposed about carrier axis A′-A″. Side panel 30 includes cushion panel 31a and this cushion panel 31a includes elevated structures or cushions 31b which are pyramid shaped in FIG. 20. Elastic panel 14 joins side panels 30,32. Tab 16 is attached to both side panels 30, 32. Cell phone or PED 8 is trapped in the interior of carrier 10 due to the lateral compression of elastic panel 14. The pyramid shapes may be hard decorative metal or plastic rather than cushion elements.

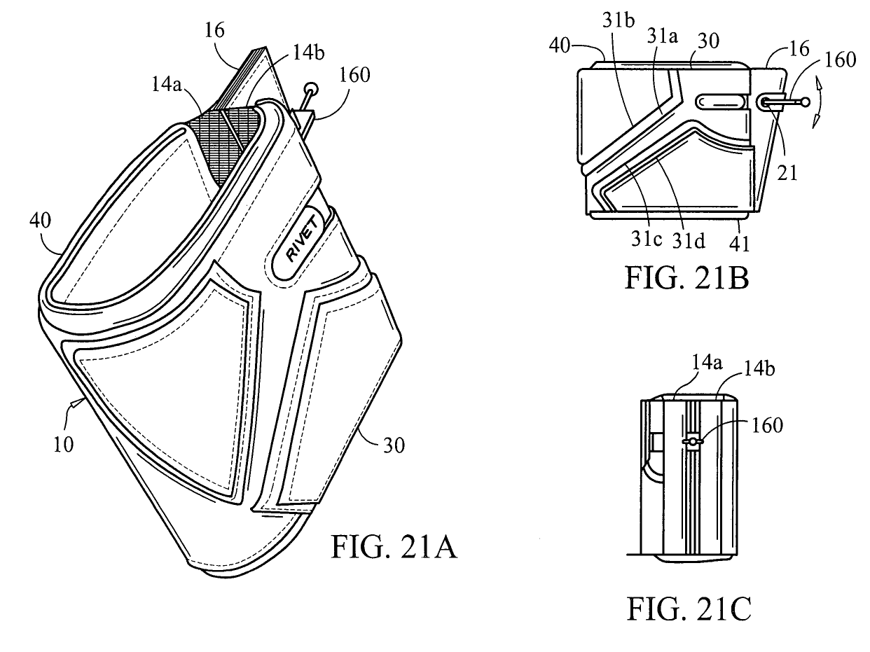

FIGS. 21a, 21b and 21c shows a carrier which includes various elements discussed earlier including protruding tab 16 which protrudes from elastic panel segments 14a, 14b. Swivel clasp element 160 is rotatably mounted in aperture 21 of tab 16. See FIG. 21b. Side panel 30 has various bands of cushion material 31a, 31b, 31c and 31d. Upper and lower cushion edges 40, 41 provide cushioning for the insertion and removal of cell phone or PED from the interior space.

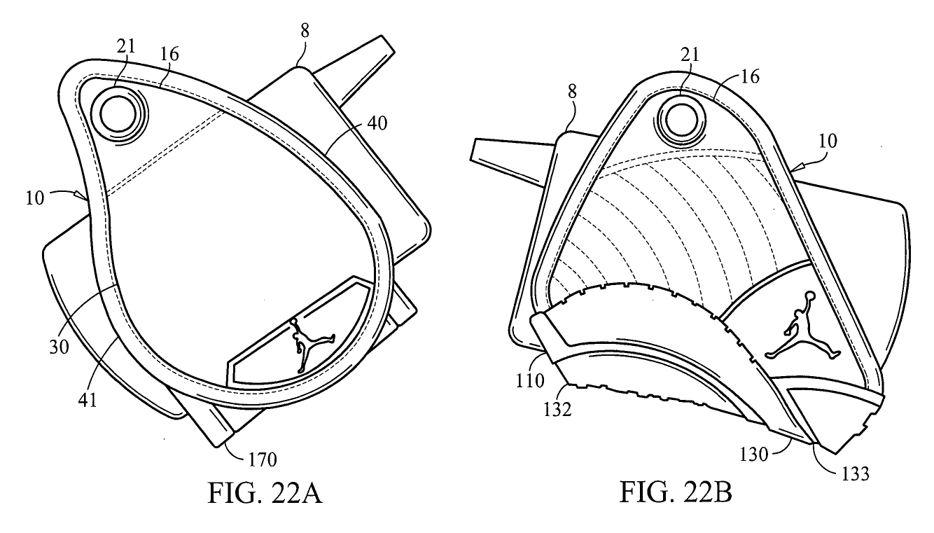

FIG. 22a shows that cell phone or PED 8 is entrapped by wrap-around carrier 10. Side panel 30 is either affixed or releasably fastened to bottom panel 170. Alternatively, there may be an elastic panel between side panel 30 and bottom panel 170.

FIG. 22b shows a carrier with bottom cap 110 having a lower elevation resilient land segment 132, a higher land resilient segment 130 and a supplemental lower land 133.

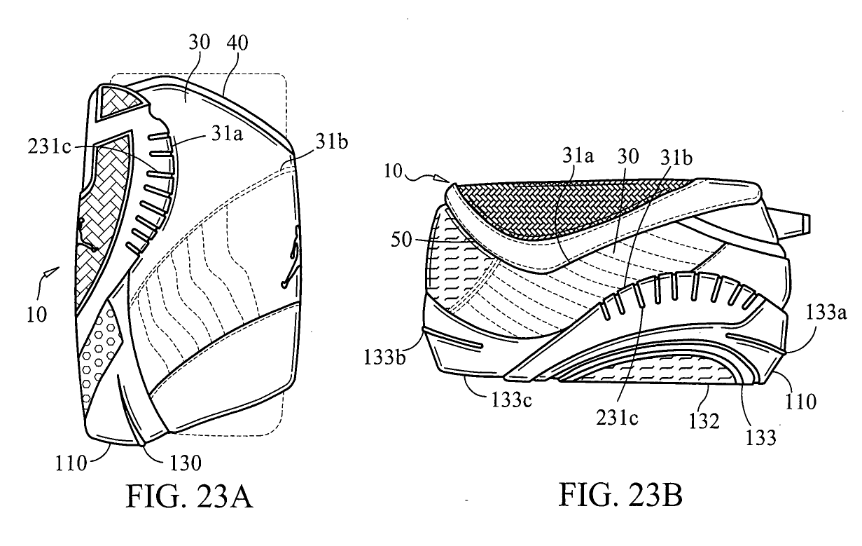

FIG. 23a shows carrier 10 with a side panel 30 and various cushion panel elevations 31a, 31b. Cushion element 31a includes a plurality of recesses 231c which provides voids such that the cushioning material 31a can fill in the void if a laterally directed force impacts side 30. Bottom cap 110 extends up a portion of side panel 30 and further includes raised land 130.

FIG. 23b shows carrier 10 with a flap element 50 which is permanently attached to side panel 30 or is releaseably affixed to side panel 30 as discussed above. Side panel 30 includes various cushioning elements one of which is element 31a and raised cushioning element 31b. Recess elevation 231c enhance the cushioning effect. Bottom cap 110 includes a plurality of different elevations as lands or recesses 132, 133, raised lands 133a, 133b and low elevational land 133c. If flap 50 is affixed to side panel 30, the cushion band 31a is part of flap 50.

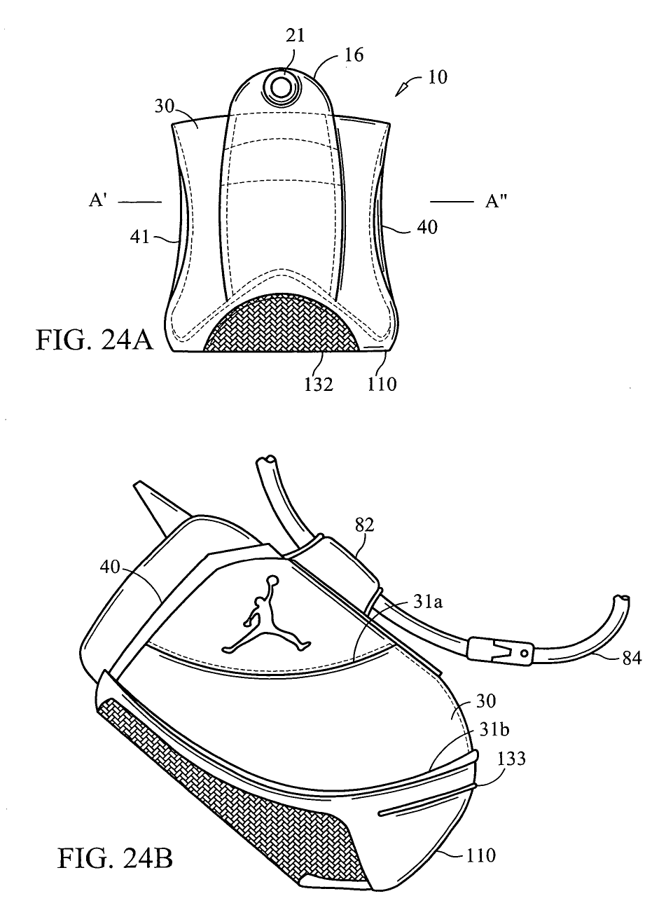

FIG. 24a shows a carrier with tab 16 extending above side panel 30. Cushion edges 40, 41 provide cushioning for the cell phone or PED which is inserted and removed along carrier axis A′-A″. Bottom cap 110 includes a reduced elevation section 132.

FIG. 24b shows a carrier with side panel 30 and cushion elements 31a, 31b. Bottom cap 110 includes raised land 133 which, in the illustrated embodiment, operates as a tactile grip.

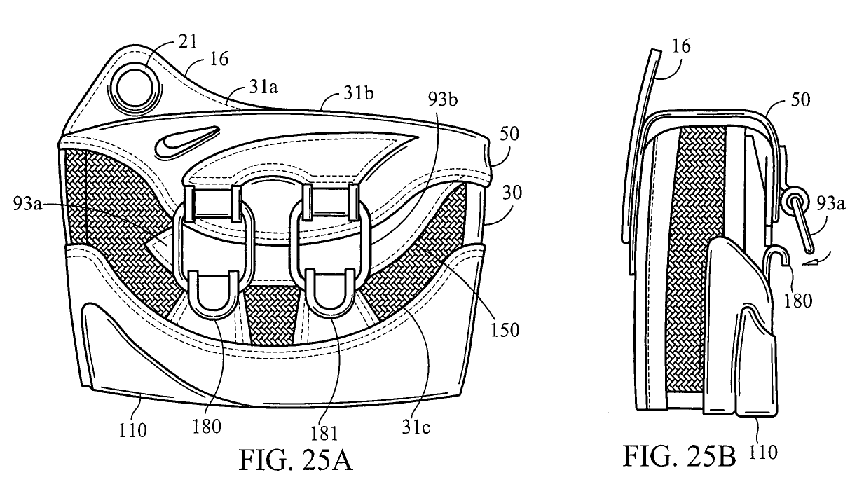

FIG. 25a shows a carrier which includes a flap 50 that is removably attached to side panel 30 by rings 23a, 23b. An elastic panel 150 may be disposed between flap 50 and side panel 30. The user, by removing the cell phone, can press flap 50 towards bottom cap 110 thereby enabling the removal of rings 93a, 93b from U shaped hooks 180, 181. This is shown in FIG. 25b.

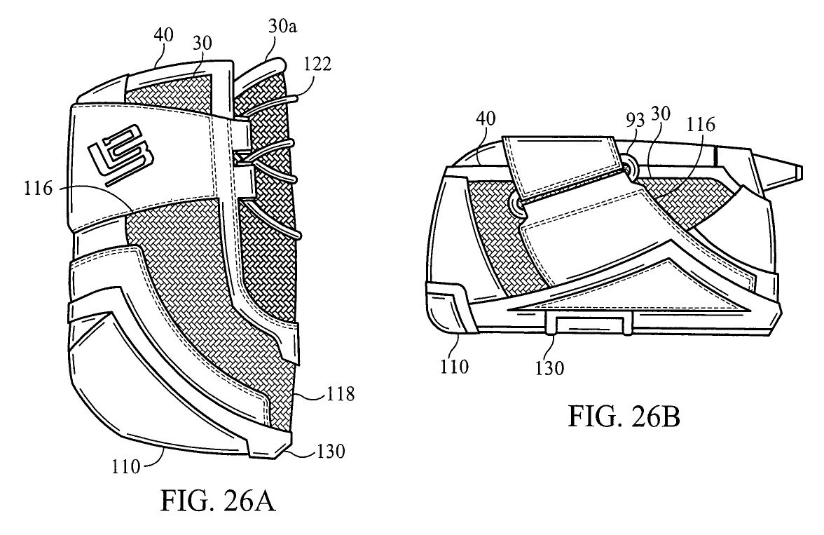

FIG. 26a shows a carrier with side panel 30 having a substantial elastic panel 118. Strap 116 spans elastic panel 118 and is adjusted by lacing system 122. Side panel element 30a cooperates with side panel 30.

FIG. 26b shows a carrier with strap 116 disposed over elastic panel 30. Details of the strap are discussed earlier herein.

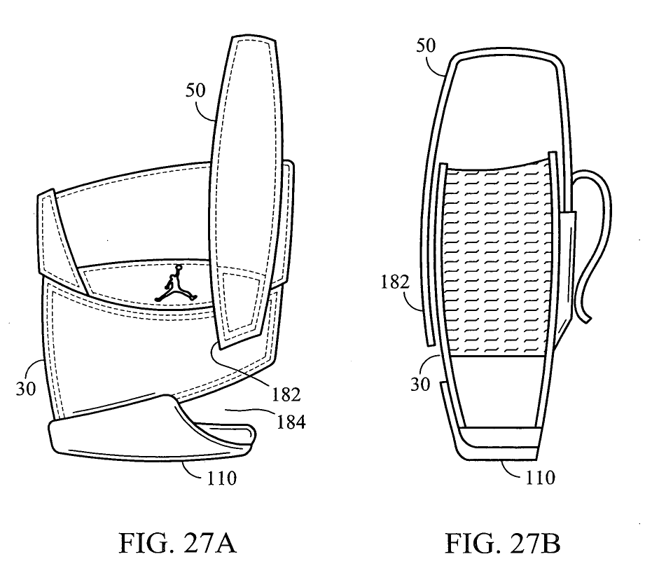

FIG. 27a shows a carrier with strap 50 with an end portion 182 removably attached to side panel 30. Bottom cap 110 partially retains the base of the cell phone or PED which is disposed in space 184.

FIG. 27b shows a carrier of FIG. 27a with flap 50 attached to side panel 30 at end segment 182. This attachment maybe a hook and loop cloth fastener, magnetic clasp, button or snap as discussed above in connection with FIGS. 9a-9c.

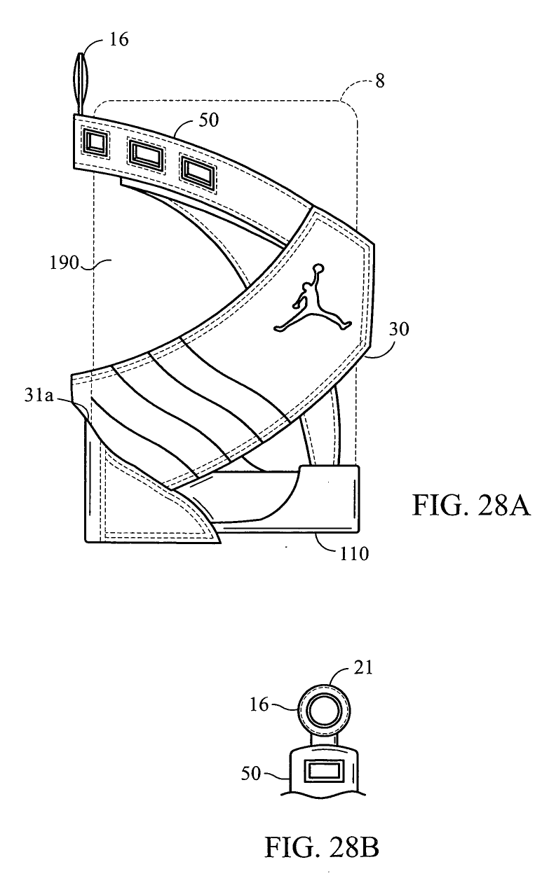

FIG. 28a shows a carrier with cell phone or PED 8 in dashed lines which phone is retained in capture space 190 via strap 50 extending above side panel 30. The base of cell phone 8 is placed in bottom cap 110. Side panel 30 has a raised cushion element 31a. The side panel 30 may have several raised cushion areas.

FIG. 28b shows a partial, side view of carrier 10 in FIG. 28a and tab 16 and aperture 21 extending above strap 50.

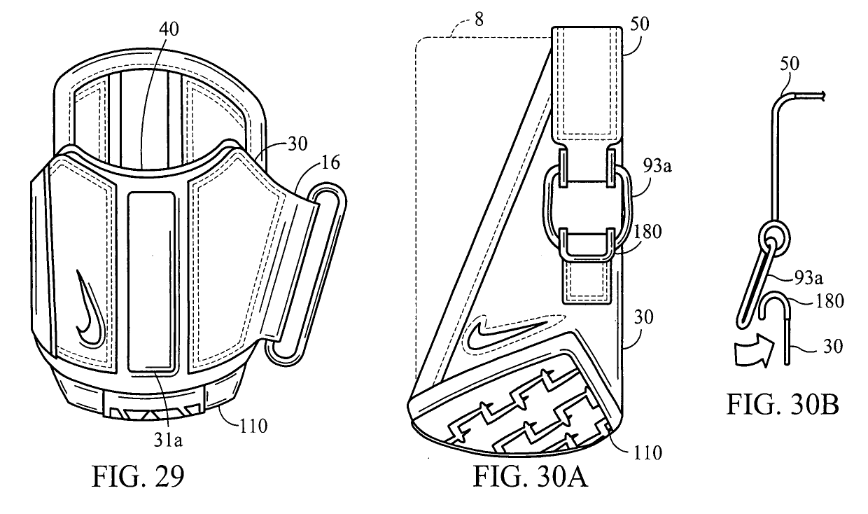

FIG. 29 shows a carrier with side panel 30 and a cushion element 31a and a protruding tab 16. A ring is mounted on tab 16.

FIGS. 30a, 30b show a carrier with strap 40 removably affixed to side panel 30 via ring 93a and U shaped hook 180. Bottom cap 110 protects the lower edge of cell phone or PED 8.

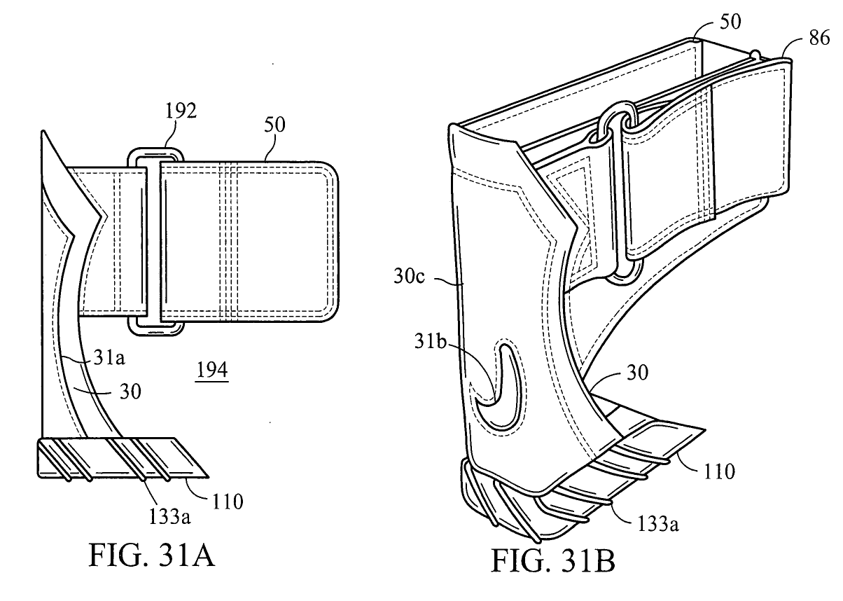

FIGS. 31a and 31b show a carrier with strap 50 and ring loop 192 linking the strap to side 30. Raised cushion element 31a is also shown on side 30. Bottom cap 110 partially secures the base of the cell phone which is placed in space 194. Raised lands 133a on bottom cap 110 provide a cushioning effect. In FIG. 31b, strap end 86 enables the user to adjust the lateral compression of strap 50 as discussed above. Raised cushioning element 31b also provides some protection from side impact on side panel 30c. The open structure of strap 50 enables the user to hear the cell phone ring.

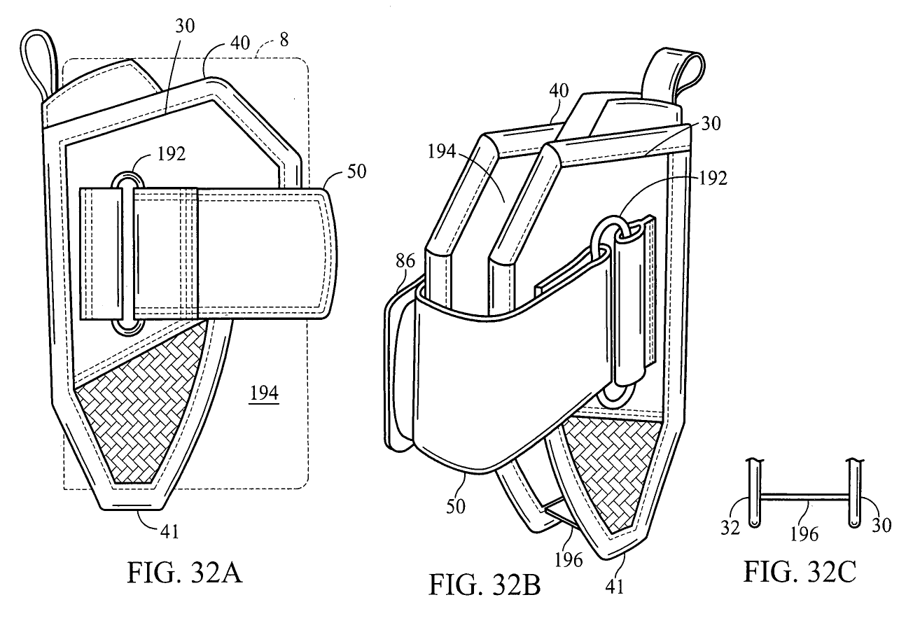

FIG. 32a shows a carrier with side panel 30 and strap system 50 which wraps around cell phone or PED 8.

FIG. 32b shows a carrier with strap end 86 which enables the user to enhance or relax the lateral compression of the wrap around system for the cell phone placed in space 194. Bottom plate 196, also shown in FIG. 32c, joins sides 30, 32 and retains the base of the cell phone or PED placed in space 194.

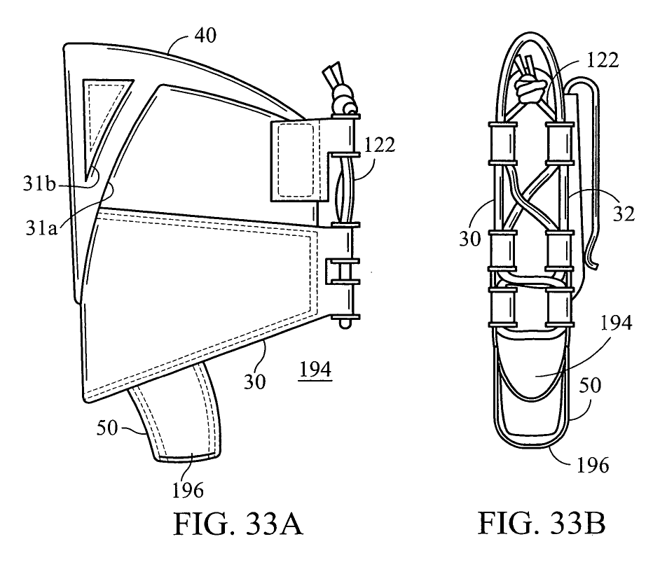

FIGS. 33a, 33b show a carrier with side 30 which is laced with lacing system 122 at the interface between sides 30, 32. Strap 50 has base element 196 which captures the base of a cell phone or PED placed in space 194. Side 30 includes raised cushion bands 31a, 31b.

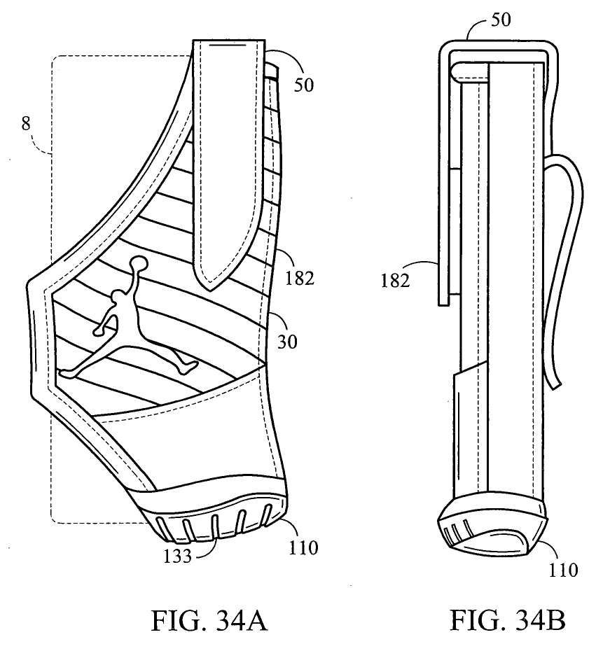

FIGS.34a, 34b show a carrier with flap 50 which is removably attached at end region 182 to side panel 30. Bottom cap 110 has elevational relief element or recessed portions 133 which provides cushioning.

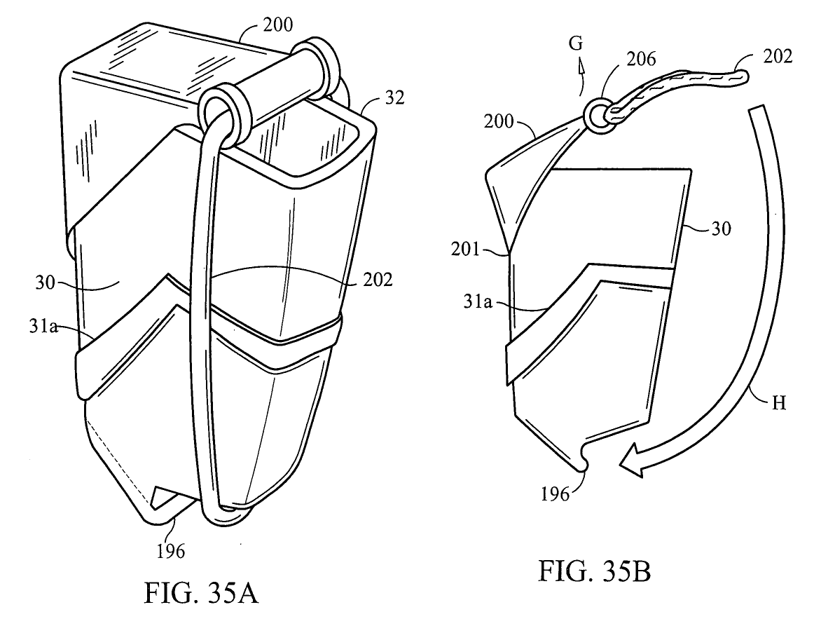

FIGS. 35a, 35b show a carrier with sides 30, 32 and a swing cap 200. Swing cap 200 is rotatably mounted preferably to sides 30, 32 such that the swing cap can be moved as shown by arrow G in FIG. 35b. A releaseable fastener 202 extends between the end 206 of spring cap 200 (see arrow H) and mounts at or near the bottom of side panel 30, 32. Bottom piece 196 retains the bottom of the cell phone or PED. Other longitudinally active releasable fasteners may be used as shown earlier herein.

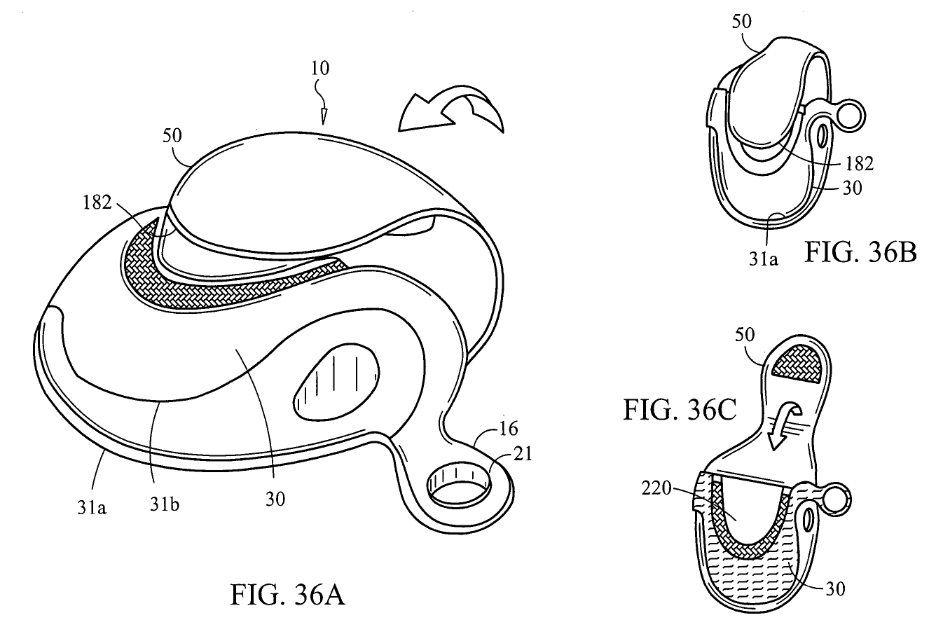

FIGS. 36a, 36b and 36c show carrier 10 with side panel 30 and a releaseable flap 50. Flap 50 has end segment 182 which cooperates with side element 220 such that the flap can be attached and removed by the user. Attachment systems discussed above in conjunction with FIGS. 9a-9c may be utilized herein. Side 30 includes cushion element 31a, 31b. A tab 16 also includes aperture 31 such that the user can attached the courier to other items.

The claims appended hereto are meant to cover modifications and changes within the scope and spirit of the present invention.

What is claimed is:

1. A carrying case for a personal electronic device from the group of personal electronic devices comprising a cell phone, a personal data assistant, a digital camera or video player, a digital memory store music player, portable game player, said carrying case comprising:
a front side, a rear side, a first opposing side and a second opposing side adapted to at least wrap about and encircle said personal electronic device, a swath of elastic at an interface between any two adjacent front side, rear side, first opposing side and second opposing side and adapted to laterally compress said personal electronic device disposed in said carrying case.

2. A carrying case as claimed in claim 1 including an externally mounted releasable fastener extending over said swath of elastic.

3. A carrying case as claimed in claim 2 wherein said releasable fastener includes a fastener from the group comprising a hook and loop cloth fastening system, a button, a snap, a belted clasp, a clasp, an elastic strap, a magnetic clasp and a lacing system with laces.

4. A carrying case as claimed in claim 1 wherein said personal electronic device includes a base portion and the carrying case includes a bottom cap fully or partly mounted to adjoining or opposing ones of said front side, rear side, first opposing side and second opposing side and adapted to fully or partly encase and protect said base of said personal electronic device in conjunction said front side, rear side, first opposing side and second opposing side.

5. A carrying case as claimed in claim 1 wherein one of said front side, rear side, first opposing side and second opposing side includes a band of externally disposed cushioning material defining a shock resilient element thereon to protect said personal electronic device.

6. A carrying case as claimed in claim 5 wherein said band of cushioning material includes one of a raised land of resilient material or a raised land of resilient plastic.

7. A carrying case as claimed in claim 5 wherein said opposing sides each include a side band of cushioning material, said band of cushioning material includes one of a raised land of resilient material or a raised land of resilient plastic.

8. A carrying case as claimed in claim 7 wherein said band of cushioning material establishes a tactile grip region about said carrying case.

9. A carrying case as claimed in claim 6 wherein said band of cushioning material establishes a tactile grip region about said carrying case.

10. A carrying case as claimed in claim 1 including a tab mounted to and extending away from said elastic swath.

11. A carrying case as claimed in claim 1 including two swaths of elastic material at another interface between any other two adjacent front side, rear side, first opposing side and second opposing side.

12. A carrying case as claimed in claim 1 wherein said swath of elastic material partly provides said interface between said two adjacent ones of said front side, rear side, first opposing side and second opposing side.

13. A carrying case for a personal electronic device from the group of personal electronic devices comprising a cell phone, a personal data assistant, a digital camera or video player, a digital memory store music player, portable game player, said carrying case comprising:
at least a first, a second and a rear side, and a swath of elastic at an adjacent interface joining two of said first, second and rear sides, which elastic swath and said first, second and rear sides are adapted to wrap about and encircle said personal electronic device and are adapted to laterally compress said personal electronic device disposed in said carrying case.

14. A carrying case as claimed in claim 13 including an externally mounted releasable fastener extending over said elastic swath.

15. A carrying case as claimed in claim 14 wherein said releasable fastener includes a fastener from the group comprising a hook and loop cloth fastening system, a button, a snap, a belted clasp, a clasp, an elastic strap, a magnetic clasp and a lacing system with laces.

16. A carrying case as claimed in claim 13 wherein said personal electronic device includes a base portion and the carrying case includes a bottom cap fully or partly mounted to said first, second and rear sides and adapted to fully or partly encase and protect said base of said cell phone or personal electronic device in conjunction said first, second and rear sides.

17. A carrying case as claimed in claim 13 wherein one of said first, second and third sides includes an external band of cushioning material defining a shock resilient element to protect said personal electronic device.

18. A carrying case as claimed in claim 17 wherein said band of cushioning material includes one of a raised land of resilient material or a raised land of resilient plastic.

19. A carrying case as claimed in claim 18 wherein said band of cushioning material establishes a tactile grip region about said carrying case.

20. A carrying case as claimed in claim 17 wherein said band of cushioning material establishes a tactile grip region about said carrying case.

21. A carrying case as claimed in claim 17 including a tab mounted to and extending away from said elastic swath.

22. A carrying case as claimed in claim 21 wherein said swath of elastic material is segmented into two swathes of elastic material and said tab is mounted between said two swathes of elastic material.

23. A carrying case as claimed in claim 13 wherein said swath of elastic material is segmented into two swathes of elastic material and the carrying case includes a tab mounted between said two swathes of elastic material, said tab extending outboard with respect to said first, second and rear sides.

24. A carrying case as claimed in claim 23 wherein said tab includes an aperture permitting said carrying case to be further attached to other devices.

25. A carrying case as claimed in claim 22 wherein said tab includes an aperture permitting said carrying case to be further attached to other devices.

26. A carrying case for a personal electronic device from the group of personal electronic devices comprising a cell phone, a personal data assistant, a digital camera or video player, a digital memory store music player, portable game player, said carrying case comprising:
at least a first, a second, a third and a rear side defining a capture cavity therebetween, and an outboard extending tab externally protruding from one of said first, second, third and rear sides, and said first, second, third and rear sides adapted to wrap about and encircle said personal electronic device when said personal electronic device is placed in said capture cavity.

27. A carrying case as claimed in claim 26 wherein said tab includes an aperture and a swivel clip is movably disposed in said aperture.

28. A carrying case for a personal electronic device from the group of personal electronic devices comprising a cell phone, a personal data assistant, a digital camera or video player, a digital memory store music player, portable game player, said carrying case comprising:
at least a first, a second, a third and a rear side defining a capture cavity therebetween, and a swing cap rotatably mounted to one of said first, second, third and rear sides such that said swing cap partially rotates outboard with respect to said capture cavity, and an externally mounted releasable fastener extending between said swing cap and one of said first, second, third and rear sides such that said fastener releasably affixes said swing cap to said one of said first, second, third and rear sides.

29. A carrying case as claimed in claim 28 wherein said releasable fastener includes a fastener from the group comprising a hook and loop cloth fastening system, a button, a snap, a belted clasp, a clasp, an elastic strap, a magnetic clasp and a lacing system with laces.
